(19) United States
(12) Patent Application Publication
(10) Pub. No.: US 2010/0164846 A1
(43) Pub. Date: Jul. 1, 2010

(54) PLASMA DISPLAY PANEL DEVICE

(76) Inventor: Ki Eon Eom, Kyungsangbuk-do (KR)

Correspondence Address: KED & ASSOCIATES, LLP, P.O. Box 221200, Chantilly, VA, 20153-1200, US

(21) Appl. No.: 12/600,520

(22) PCT Filed: Dec. 1, 2008
(86) PCT No.: PCT/KR08/07076

§ 371 Date: Nov. 17, 2009

(30) Foreign Application Priority Data
Dec. 3, 2007 (KR) 10-2007-0124421

(51) Int. Cl. G09G 3/28

(52) U.S. Cl. 345/60

(57) ABSTRACT

A plasma display panel (PDP) device includes: a PDP including a plurality of panel electrodes; a driving circuit to generate a drive signal to drive the panel; and a flexible printed circuit (FPC) positioned between the panel and a driving board with the driving circuit implemented thereon and transferring the drive signal to the plurality of panel electrodes, wherein the FPC includes a plurality of FPC electrodes formed on a base film and compressed with the plurality of panel electrodes and a cover lay film stacked on the plurality of FPC electrodes and the base film, and a virtual extension line connecting end portions of two adjacent electrodes among the plurality of panel electrodes and the cover lay film are separated by a certain distance. Accordingly, a short phenomenon between adjacent electrodes among the plurality of panel electrodes can be prevented.

### TECHNICAL FIELD

The present invention relates to a plasma display panel (PDP) device and, more particularly, to a PDP device for preventing a short phenomenon due to conductive balls contained in a conductive material when a plurality of panel electrodes and a plurality of FPC electrodes are thermo-compressed.

### BACKGROUND ART

In addition, the PDP device is also advantageous in that it can be easily increased in size and become thinner, easily fabricated with a simpler structure, and has high luminance and luminous efficiency compared with other flat panel display devices.

The related art PDP device includes a PDP with a plurality of panel electrodes formed thereon, a driving board including a driving circuit that outputs drive signals to the plurality of panel electrodes, and a flexible printed circuit (FPC) positioned between the plurality of panel electrodes and the driving board, and transferring the driver signals outputted from the driving circuit to the plurality of panel electrodes.

Here, a conductive material including conductive balls for thermo-compressing the plurality of panel electrodes and a plurality of FPC electrodes included in the FPC are formed, and a cover lay film is stacked on the FPC electrodes.

Recently, research is ongoing to prevent a short phenomenon between neighboring electrodes among a plurality of panel electrodes thermo-compressed with first and second ones of the plurality of FPC electrodes of the FPC, because the conductive balls contained in the conductive material does not spread to the cover lay film in performing thermo-compression at a space between the first and second FPC electrodes.

### DISCLOSURE OF INVENTION

### Technical Problem

The present invention is designed to solve such a problem of the related art, and therefore, an object of the present invention is to provide a plasma display panel (PDP) device for preventing a short phenomenon due to conductive balls included in an adhesive when a plurality of electrodes and a plurality of FPC electrodes are thermo-compressed.

### Technical Solution

To achieve the above objects, there is provided in one aspect a plasma display panel (PDP) device including: a PDP including a plurality of panel electrodes; a driving circuit to generate a drive signal to drive the panel; and a flexible printed circuit (FPC) positioned between the panel and a driving board with the driving circuit implemented thereon and transferring the drive signal to the plurality of panel electrodes, wherein the FPC includes a plurality of FPC electrodes formed on a base film and compressed with the plurality of panel electrodes and a cover lay film stacked on the plurality of FPC electrodes and the base film, and a virtual extension line connecting end portions of two adjacent electrodes among the plurality of panel electrodes and the cover lay film are separated by a certain distance.

To achieve the above object, there is provided in another aspect a plasma display panel (PDP) device including: a PDP including a plurality of panel electrodes; a driving circuit to generate a drive signal to drive the panel; and a flexible printed circuit (FPC) positioned between the panel and a driving board with the driving circuit implemented thereon and transferring the drive signal to the plurality of panel electrodes, wherein the FPC includes a plurality of FPC electrodes formed on a base film and compressed with the plurality of panel electrodes and a cover lay film stacked on the plurality of FPC electrodes and the base film, the cover lay film includes convex portions facing the plurality of panel electrodes and concave portions formed between the convex portions, and a virtual extension line connecting end portions of two adjacent electrodes among the plurality of panel electrodes and the concave portions of the cover lay film are separated by a certain distance.

To achieve the above object, there is provided in still another aspect a plasma display panel (PDP) device including: a PDP including a plurality of panel electrodes; a driving circuit to generate a drive signal to drive the panel; and a flexible printed circuit (FPC) positioned between the panel and a driving board with the driving circuit implemented thereon and transferring the drive signal to the plurality of panel electrodes, wherein the FPC includes a plurality of FPC electrodes formed on a base film and compressed with the plurality of panel electrodes and a cover lay film stacked on the plurality of FPC electrodes and the base film, the cover lay film includes a first layer having at least one step with a first height and a second layer formed with a second height on the first layer, the second layer includes convex portions facing the plurality of panel electrodes and concave portions formed between the convex portions, and a virtual extension line connecting end portions of two adjacent electrodes among the plurality of panel electrodes and the concave portions of the cover lay film are separated by a certain distance.

### ADVANTAGEOUS EFFECTS

In the PDP device according to the present invention, the cover lay film has a step or is stacked by being separated at a certain distance to prevent the occurrence of a short due to conductive balls included in a conductive material between panel electrodes in connecting the plurality of FPC electrodes included in the FPC and the plurality of panel electrodes on the PDP, so that a defective rate and operability of a fabrication process can be improved.

In addition, because the cover lay film included in the FPC is stacked with a step, a short phenomenon between adjacent electrodes among a plurality of panel electrodes due to conductive balls when the plurality of panel electrodes and the plurality of FPC electrodes are thermo-compressed, so an error rate in the fabrication process can be reduced and the productivity can be increased.

Also, because the cover lay film is stacked such that it is separated by a certain distance from end portions of the plurality of panel electrodes, the operation efficiency can be improved and an error rate in the operation process can be reduced.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing the structure of a plasma display panel (PDP) according to a first embodiment of the present invention.

FIG. 2 is a schematic block diagram showing the structure of a PDP device according to the first embodiment of the present invention.

FIG. 3 is a perspective view showing a panel and an FPC of the PDP device according to the first embodiment of the present invention.

FIG. 4 is a perspective view showing an FPC connection structure of FIG. 3.

FIG. 5 is a perspective view showing a panel and an FPC of a PDP device according to a second embodiment of the present invention.

FIG. 6 is a perspective view showing an FPC connection structure of FIG. 5.

FIG. 7 is a perspective view showing a panel and an FPC of a PDP device according to a third embodiment of the present invention.

FIG. 8 is a perspective view showing an FPC connection structure of FIG. 7.

### BEST MODE FOR CARRYING OUT THE INVENTION

A flat panel display device according to the exemplary embodiments of the present invention will now be described with reference to the accompanying drawings. Hereinbelow, a plasma display panel (PDP) device will be taken as an example to describe the flat panel display device, but the present invention is not limited to the PDP device but can be applicable to other flat panel display devices such as a liquid crystal display (LCD) device, an organic light emitting diode (OLED) device, or the like.

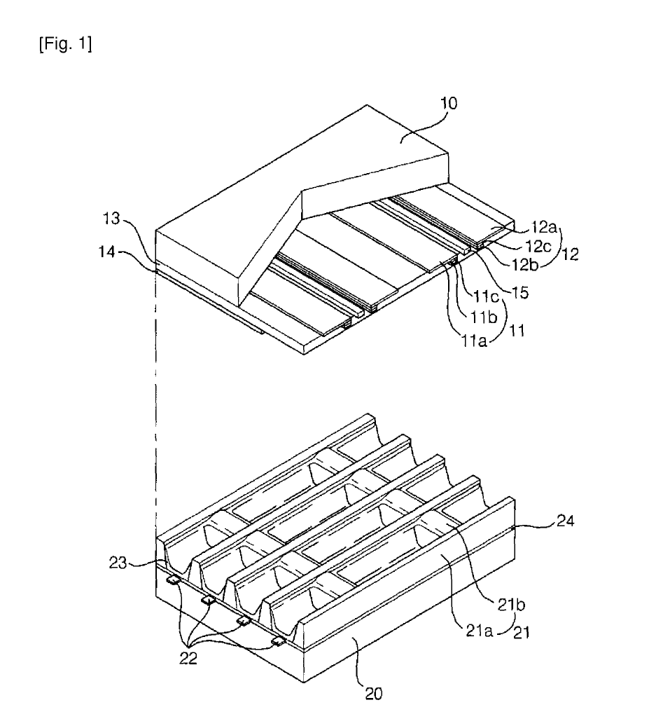

FIG. 1 is a perspective view showing the structure of a plasma display panel (PDP) according to a first embodiment of the present invention.

With reference to FIG. 1, a plasma display panel (PDP) includes a front panel (not shown) and a rear panel (not shown).

The front panel includes scan electrodes 11 and sustain electrodes 12, pairs of sustain electrodes, formed on an upper substrate 10, and the rear panel includes address electrodes 22 formed on a lower substrate 20.

The pair of sustain electrodes 11 and 12 include transparent electrodes 11a and 12a generally made of indium-tin-oxide (ITO) and bus electrodes 11b and 12b. The bus electrodes 11b and 12b may be formed of a metal such as silver (Ag), chromium (Cr), or the like, or formed as stacked type electrodes of chromium/copper/chromium (Cr/Cu/Cr) or chromium/aluminum/chromium (Cr/Al/Cr). The bus electrodes 11b and 12b are formed on the transparent electrodes 11a and 12a to reduce a voltage drop due to the transparent electrodes 11a and 12a with a high resistance.

According to the first embodiment of the present invention, the sustain electrodes 11 and 12 may not only have the structure that the transparent electrodes 11a and 12a and the bus electrodes 11b and 12b are stacked but also include only the bus electrodes 11b and 12b without the transparent electrodes 11a and 12a. The latter structure is advantageous in that the unit cost of the panel fabrication can be reduced because it does not use the transparent electrodes 11a and 12a. The bus electrodes 11b and 12b used for this structure may be made of various materials such as a photosensitive material besides the above-mentioned materials.

A black matrix 15 is arranged between the transparent electrodes 11a and 12a and between the bus electrodes 11b and 12b of the scan electrode 11 and the sustain electrode 12 and performs a light blocking function of absorbing external light generated from outside of the upper substrate 10 to reduce light reflection and a function of improving the purity and contrast of the upper substrate 10.

The black matrix 15 is formed on the upper substrate 10 and includes a first black matrix 15 formed at a position overlapping with a barrier rib 21 and second black matrixes 11c and 12c formed between the transparent electrodes 11a and 12a and the bus electrodes 11b and 12b. Here, the first black matrix 15 and the second black matrixes 11c and 12c called a black layer or a black electrode layer may be simultaneously formed to be physically connected in their formation process or may not be simultaneously formed nor physically connected.

When the first black matrix 15 and the second black matrixes 11c and 12c are formed to be physically connected, they may be made of the same material, while if they are separately formed, they may be made of each different material.

An upper dielectric layer 13 and a passivation layer 14 are stacked on the upper substrate 10 with the scan electrodes 11 and the sustain electrodes 12 formed to be parallel thereon. Charged particles generated through discharging are accumulated on the upper dielectric layer 13, and the upper dielectric layer 13 may serve to protect the pairs of sustain electrodes 11 and 12. The passivation layer 14 protects the upper dielectric layer 13 against sputtering of the charged particles generated during a gas discharge, and increases the discharge efficiency of secondary electrons.

In addition, the address electrodes 22 are formed to cross the scan electrodes 11 and the sustain electrodes 12. A lower dielectric layer 24 and barrier ribs 21 are formed on the lower substrate 20 with the address electrodes 22 formed thereon.

A phosphor layer 23 is formed on the surface of the lower dielectric layer 24 and the barrier ribs 21. The barrier ribs 21 include vertical barrier ribs 21 and horizontal barrier ribs 21b formed in a closed form, physically discriminate discharge cells, and prevent a leakage of ultraviolet rays and visible light generated according to discharging to an adjacent discharge cell.

In the first embodiment of the present invention, the barrier ribs 21 may not only have such a form as shown in FIG. 1 but various other structures. For example, the barrier ribs 21 may have a differential type barrier rib structure in which the vertical barrier ribs 21a and the horizontal barrier ribs 21b have each different height, a channel type barrier structure in which a channel that can be used as an exhaust path is formed at least one of the vertical barrier ribs 21a and the horizontal barrier ribs 21b, and a hollow type barrier rib structure in which a hollow is formed on at least one of the vertical barrier ribs 21a and the horizontal barrier ribs 21b.

Here, in case of the differential type barrier rib structure, the height of the horizontal barrier ribs 21b is preferably higher, and in case of the channel type barrier rib structure or the hollow type barrier rib structure, a channel or a hollow is preferably formed at the horizontal barrier ribs 21b.

In the first embodiment of the present invention, R, G, and B discharge cells are arranged on the same line, but they may be arranged in a different shape. For example, the R, G, and B discharge cells may be arranged in a delta type, namely, they can be arranged in a triangular shape. In addition, the R, G, and B discharge cells may also be arranged in various polygonal shapes such as a square, pentagonal, hexagonal shape, or the like.

The phosphor layer 23 is excited by ultraviolet rays generated during a gas discharge to emit one of visible lights of red (R), green (G), and blue (B). Here, an inert mixture gas such as He+Xe, Ne+Xe, He+Ne+Xe, or the like, is injected into the discharge spaces between the upper and lower substrates 10 and 20 and the barrier ribs 21, to perform discharging.

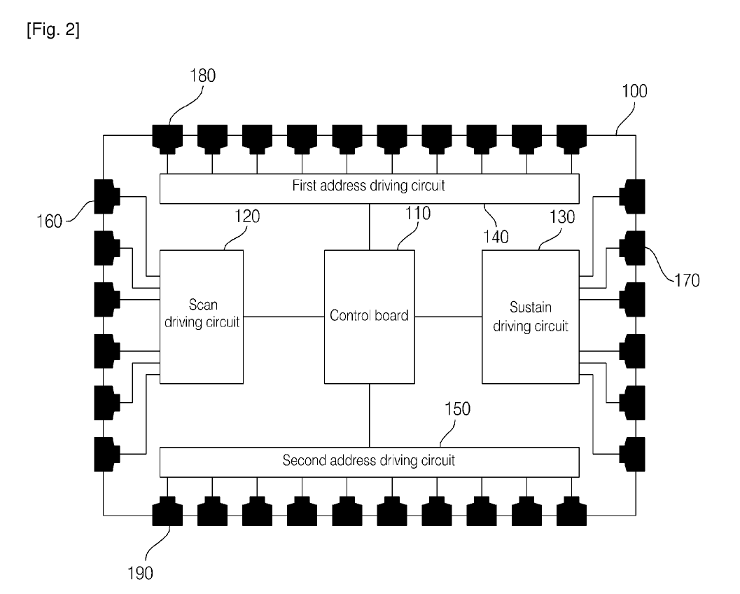

FIG. 2 is a schematic block diagram showing the structure of a PDP device according to the first embodiment of the present invention.

With reference to FIG. 2, the PDP device includes a PDP 100, a control board 110, a scan driving circuit 120, a sustain driving circuit 130, first and second address driving circuits 140 and 150, and connection members 160, 170, 180, and 190.

Here, in the first embodiment of the present invention, the address driving circuits and the scan driving circuits are separately described, but the present invention is not limited thereto, and the two address driving circuits may be integrated into a single address driving circuit or the address driving circuits and the scan driving circuit may be integrated.

In order to drive the PDP 100, the scan driving circuit 120, the sustain driving circuit 130, and the first and second address driving circuits 140 and 150 generate drive signals to be applied to the scan electrodes, the sustain electrodes and the address electrodes among the plurality of electrodes.

The control board 110 generates control signals according to image signals to be displayed and outputs the control signals to the scan driving circuit 120, the sustain driving circuit 130, and the first and second address driving circuits 140 and 150 to control the operations of the driving circuits 120, 130, 130, 140, and 150 overall.

With reference to FIG. 2, the control board 110, a driving board including the scan driving circuit 120, the sustain driving circuit 130, the first and second address driving circuits 140 and 150, and the connection members 160, 170, 180, and 190 are formed on the rear surface of the PDP 100. Preferably, a chassis base (not shown) is positioned between the PDP 100 and the driving board to support the panel. Thus, preferably, the PDP with such a structure as shown in FIG. 1 is attached on one surface of the chassis base, and the driving board is attached to another surface of the chassis base. The chassis base is required to serve to release heat by uniformly dispersing high-temperature heat generated from the PDP as well as supporting the panel, for which, thus, the chassis base may be fabricated with material with good heat conductivity and rigidity, e.g., aluminum.

In order to apply drive signals generated by electrically connecting the scan driving circuit 120, the sustain driving circuit 130, the first and second address driving circuits 140 and 150, and the PDP 100, the PDP device according to the present invention includes the connection members 160, 170, 180, and 190 connected with the plurality of electrodes.

Each of the connection members 160, 170, 180, and 190 receive drive signals from the scan driving circuit 120, the sustain driving circuit 130, and the first and second address driving circuits 140 and 150 and applies them to the panel electrodes of the connected PDP 100.

The connection members 160, 170, 180, and 190 may be configured as a COF (Chip On Film), a TCP (Tape Carrier Package), or the like. The COF refers to a chip formed on a flexible printed circuit (FPC) connecting the PDP and the driving board including the driving circuits 120, 130, 140, and 150 in order to apply drive signals to the electrodes. In the TCP, the front and rear sides of the chip for applying driving signals to the electrodes are connected with the PDP 100 and the driving boards 120, 130, 140, and 150.

The FPC included in the connection members 160, 170, 180, and 190 of the PDP device will now be described.

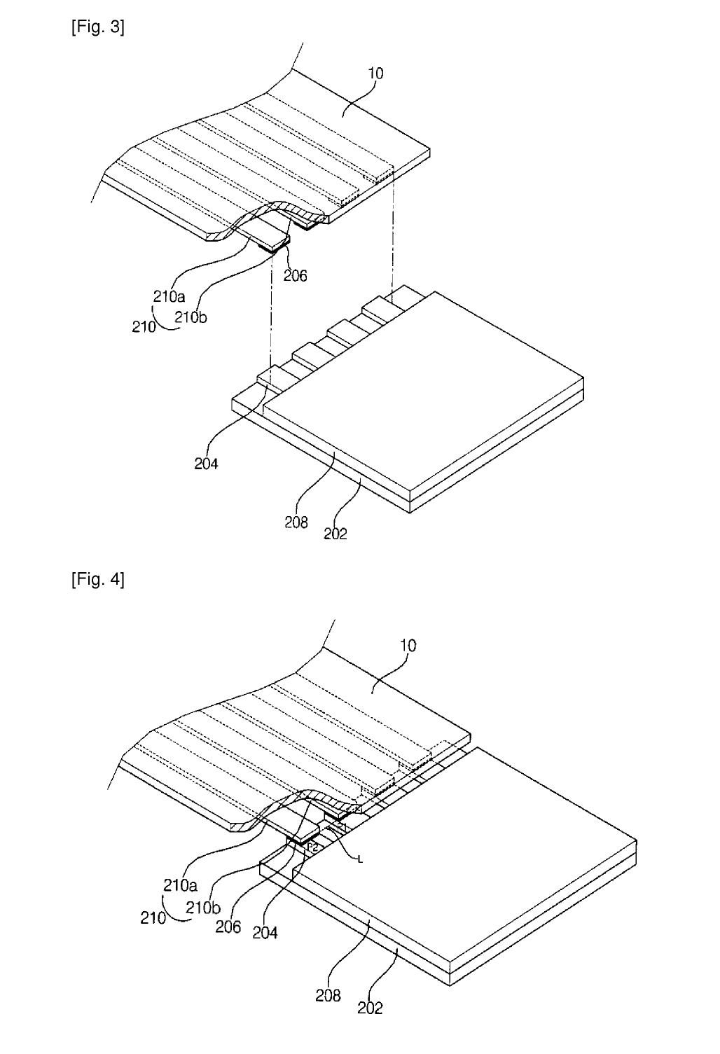

FIG. 3 is a perspective view showing a panel and an FPC of the PDP device according to the first embodiment of the present invention, and FIG. 4 is a perspective view showing an FPC connection structure of FIG. 3.

Specifically, FIG. 3 shows a state that the panel and the FPC are not connected yet, and FIG. 4 shows a state that the panel and the FPC are connected.

The first electrode 210 may be one of the scan electrode and sustain electrode, the pair of sustain electrodes formed on the upper substrate 10. In addition, the first electrode 210 may include at least one of a transparent electrode and a bus electrode.

In FIGS. 3 and 4, the scan electrode and the sustain electrode, namely, the pair of sustain electrodes, are simply denoted as the first electrode 210. The first electrode 210 has been described above with reference to FIG. 1, so the repeated portion will be omitted or simply described.

An FPC includes a base film 202, a first FPC electrode 204 stacked on the base film 202 and contacting with the first electrode 210 formed on the PDP, and a cover lay film 208 stacked on the first FPC electrode 204 and the base film 202. A conductive material 206 may be used to thermo-compress the first FPC electrode 204 and the first electrode 210.

Here, the conductive material 206 contains conductive balls including metal particles, metal plated resin particles, or the like and conducts the first electrode 210 and the first FPC electrode 204 by means of the conductive balls.

It is shown that the conductive material 206 is stacked on the first electrode 210, but without being limited thereto, the conductive material 206 may be stacked on the first FPC electrode 204.

The conductive balls may have a size of 2 μm to 5 μm. If the conductive balls have a size smaller than 2 μm, the first electrode 210 and the first FPC electrode 204 could not be conducted when thermo-compressed. If the conductive balls have a size larger than 5 μm, they would not be broken when thermo-compressed, increasing a short occurrence rate between neighboring first electrodes.

For reference, the conductive material 206 may be attached by using an anisotropic conductive film (ACF). The ACF is a thermo-compressed film formed by distributing conductive particles of metal particles, metal plated resin particles, or the like, to a thermosetting resin binder such as epoxy, urethane, or the like. In order to connect the first electrode 210 and the first FPC electrode 204 with metal particles, the ACF may have conductivity in a thickness direction of the film and an anisotropic conductivity called insulation characteristics in a surface direction of the film.

The first electrode 210 and the first FPC electrode 204 are attached by melting the thermosetting resin binder by applying heat of high temperature of high pressure to the ACP by using a compression head tip, and as the conductive balls included in the ACF are pressed by the compression head tip so as to conduct the upper and lower portions.

Here, the cover lay film 208 is stacked on the base film 202 to cover the first FPC electrode 204 such that it is separated by a certain distance P1 from a virtual extension line (L) connecting end portions of the two adjacent electrodes 210a and 210b of the first electrode 210. In particular, the cover lay film 208 in FIGS. 3 and 4 is integrally formed so that a distance P2 between the cover lay film 208 and the end portion of the first electrode 210 may be the same as the certain distance P2 between the cover lay film 208 and the virtual extension line (L).

Here, the certain distance P1 may be 1.5 mm to 4 mm. Namely, when the first electrode 210 and the first FPC electrode 204 are thermo-compressed to be conducted, the conductive material 206 between the first electrode 210 and the first FPC electrode 204 spreads to thereby prevent a short phenomenon between the first electrode 210 and a neighboring electrode (not shown) by the conductive balls.

Here, if the certain distance P1 is smaller than 1.5 mm, a short phenomenon would occur with a high probability by the conductive balls while the conductive material 206 is spreading by the interface of the cover lay film 208. If the certain distance P1 is larger than 4 mm, it goes beyond a spreading range of the conductive material 206, causing the first FPC electrode 204 to be corroded or damaged by a foreign material.

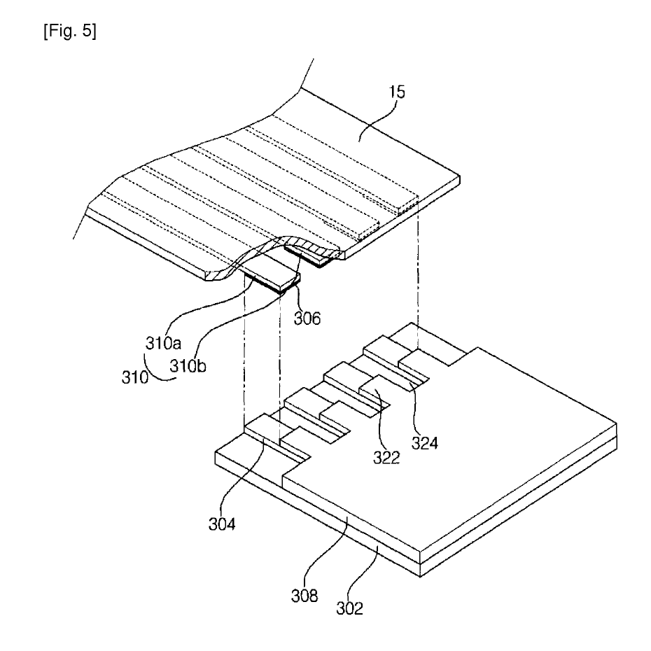

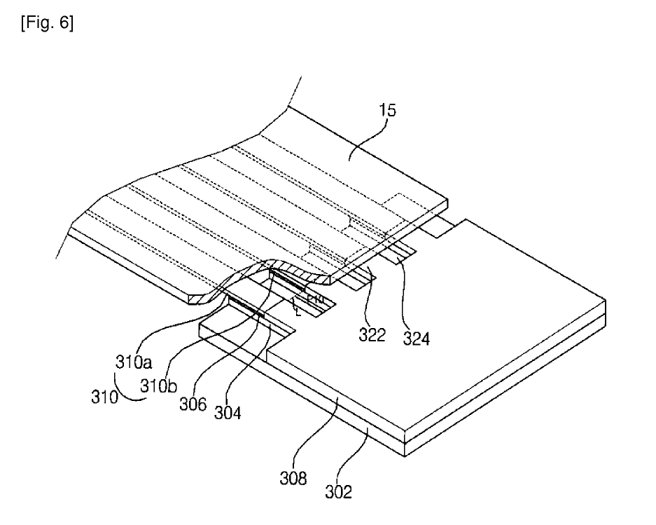

FIG. 5 is a perspective view showing a panel and an FPC of a PDP device according to a second embodiment of the present invention, and FIG. 6 is a perspective view showing an FPC connection structure of FIG. 5.

Specifically, FIG. 5 shows a state that the panel and the FPC are not connected yet, and FIG. 6 shows a state that the panel and the FPC are connected.

In describing FIGS. 5 and 6, repeated portions as those of FIGS. 3 and 4 will be simply described or omitted.

A cover lay film 308 in FIGS. 5 and 6 includes convex portions 322 and concave portions 324.

The convex portions 322 face the first electrodes 310 and the concave portions come between the convex portions 322. Namely, the cover lay film 308 may have a concavo-convex structure.

It is shown that the convex portions 322 of the cover lay film 308 are in contact with the first electrodes 310 while the concave portions 324 do not, but without being limited thereto, the convex portions 322 of the cover lay film 308 may be separated by a certain distance from the first electrodes 310. Namely, as shown in FIGS. 3 and 4, the cover lay film 308 may be entirely separated from the first electrodes 310.

As for the cover lay film 308 with such a structure, a conductive material 306 used for thermo-compression to connect the first electrode 310 and an FPC electrode 304 is allowed to spread to a base film 302 around the first electrode 310 to make conductive balls contained in the conductive material 306 spread.

Namely, the conductive balls spread in the direction of the concave portions 324 of the cover lay film 308 to prevent a short phenomenon between the adjacent first electrodes 310a and 310b.

To this end, the cover lay film 308 is stacked on the base film 302 to cover the first FPC electrode 304 such that it is separated by a certain distance P10 from a virtual extension line (L) connecting end portions of the two adjacent electrodes 310a and 310b of the first electrode 310. In detail, the concave portion 324 of the cover lay film 308 is separated by the certain distance P10 from the virtual extension line (L) connecting the end portions of the two adjacent electrodes 310a and 310b of the first electrode 310.

Here, the certain distance P10 may be 1.5 mm to 4 mm.

If the certain distance P10 is smaller than 1.5 mm, a short phenomenon would occur with a high probability by the conductive balls while the conductive material 206 is spreading by the interface of the cover lay film 308. If the certain distance P10 is larger than 4 mm, it goes beyond a spreading range of the conductive material 306, causing the first FPC electrode 304 to be corroded or damaged by a foreign material.

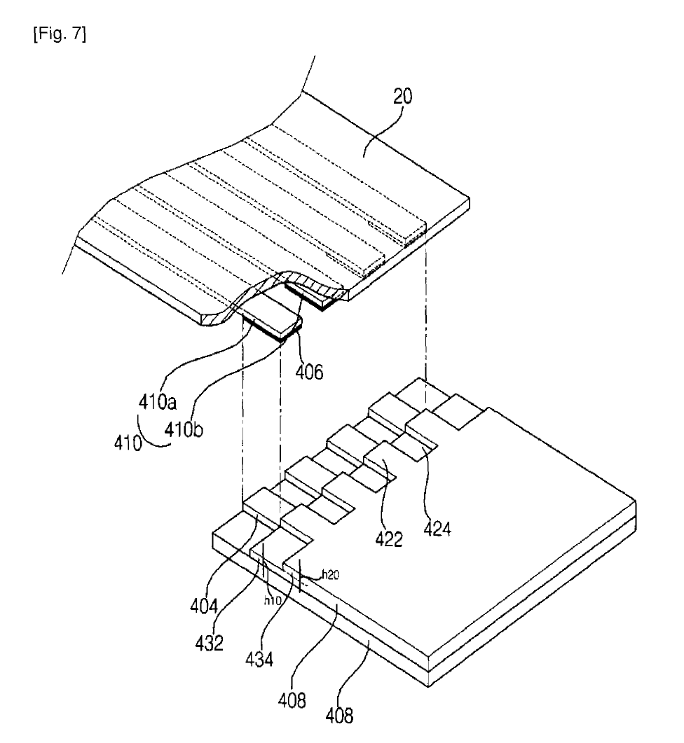

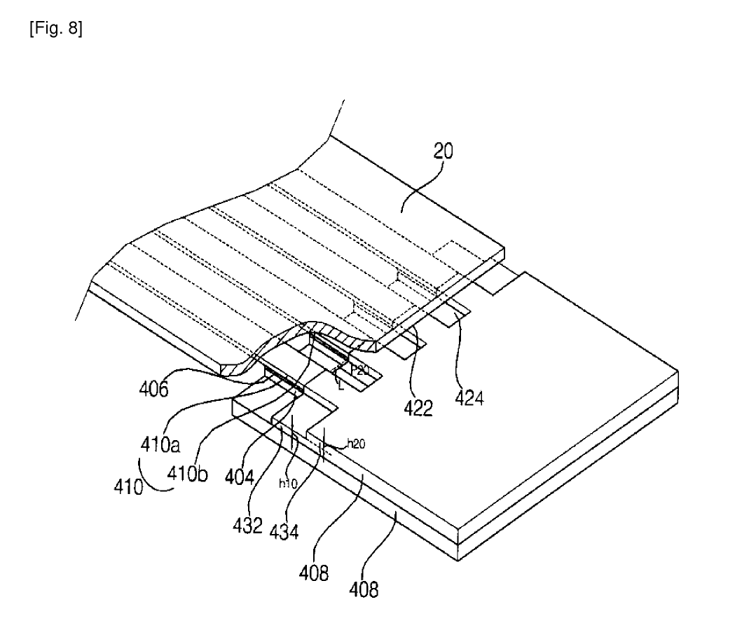

FIG. 7 is a perspective view showing a panel and an FPC of a PDP device according to a third embodiment of the present invention, and FIG. 8 is a perspective view showing an FPC connection structure of FIG. 7.

Specifically, FIG. 7 shows a state that the panel and the FPC are not connected yet, and FIG. 8 shows a state that the panel and the FPC are connected.

In describing FIGS. 7 and 8, repeated portions as those of FIGS. 3 and 4 will be simply described or omitted.

A cover lay film 408 in FIGS. 7 and 8 includes at least one step. For example, a single step may be formed as shown in FIGS. 7 and 8. The cover lay film 408 in FIGS. 7 and 8 may include a first layer 432 formed with a first height h10 and a second layer 434 formed with a second height h20 on the first layer 432.

Here, the second layer 434 of the cover lay film 408 may include a convex portion 422 and a concave portion 424.

The convex portion 422 faces a first electrode 410, and the concave portion 424 is formed between the convex portions 422. Namely, the second layer 434 of the cover lay film 408 may have a concavo-convex structure.

It is shown that the convex portion 422 of the second layer 434 of the cover lay film 408 is in contact with the first electrode 410 while the concave portion 424 does not, but without being limited thereto, the convex portion 422 of the cover lay film 408 may be separated by a certain distance from the first electrode 410. Namely, as shown in FIGS. 3 and 4, the cover lay film 408 may be entirely separated from the first electrodes 410, or only the second layer 434 of the cover lay film 408 may be separated from the first electrode 410.

As for the cover lay film 408 with such a structure, a conductive material 406 used for thermo-compression to connect the first electrode 410 and an FPC electrode 404 is allowed to spread to a base film 402 around the first electrode 410 to make conductive balls contained in the conductive material 406 spread.

Namely, the conductive balls spread in the direction of the concave portions 424 of the second layer 434 of the cover lay film 408 to prevent a short phenomenon between the adjacent first electrodes 410a and 410b.

To this end, the cover lay film 408 is stacked on the base film 302 to cover the first FPC electrode 304 such that it is separated by a certain distance P20 from a virtual extension line (L) connecting end portions of the two adjacent electrodes 410a and 410b of the first electrode 410. In detail, the concave portion 424 of the second layer 434 of the cover lay film 408 is separated by the certain distance P20 from the virtual extension line (L) connecting the end portions of the two adjacent electrodes 410a and 410b of the first electrode 410.

Here, the certain distance P20 may be 1.5 mm to 4 mm.

If the certain distance P20 is smaller than 1.5 mm, a short phenomenon would occur with a high probability by the conductive balls while the conductive material 406 is spreading by the interface of the cover lay film 408. If the certain distance P20 is larger than 4 mm, it goes beyond a spreading range of the conductive material 406, causing the first FPC electrode 404 to be corroded or damaged by a foreign material.

Of the cover lay film 408 in FIGS. 7 and 8, the height h10 of the first layer 432 and the height h20 of the second layer 434 may be different. In detail, the height h10 of the first layer 432 may be smaller than the height h20 of the second layer 434.

If the first height h10 is smaller than the second height h20, the conductive material, for example, the conductive balls can easily spread beyond the first height h10.

The first height h10 may be 20 μm to 30 μm, and the second height h20 may be 40 μm to 50 μm. If the first height h10 is smaller than 20 μm, there is a difficulty in terms of the fabrication process. If the first height is larger than 30 μm, it would be difficult for the conductive balls to spread in the direction of the concave portions 424. In addition, if the second height h20 is smaller than 40 μm, the conductive balls that have spread beyond the first layer 432 may spread beyond the second layer 434 to other parts. If the second height h20 is larger than 50 μm, the overall flexibility of the FPC would deteriorate.

The above-described embodiments are focused on the FPC between the PDP and the driving circuits, but the present invention is not limited thereto. Namely, the present invention can be applicable to any connection members between various types of panels such as a liquid crystal panel, a passive organic light emitting display panel, an active organic light emitting display panel, or the like, besides the PDP, and driving circuits.

### INDUSTRIAL APPLICABILITY

The present invention can be applied to a display device to prevent a short phenomenon due to conductive balls contained in a conductive material when a plurality of panel electrodes and a plurality of FPC electrodes are thermo-compressed.

1. A plasma display panel device comprising:
a plasma display panel comprising a plurality of panel electrodes;
a driving circuit to generate a drive signal to drive the panel; and
a flexible printed circuit (FPC) positioned between the panel and a driving board with the driving circuit implemented thereon and transferring the drive signal to the plurality of panel electrodes,
wherein the FPC comprises a plurality of FPC electrodes formed on a base film and compressed with the plurality of panel electrodes and a cover lay film stacked on the plurality of FPC electrodes and the base film, and a virtual extension line connecting end portions of two adjacent electrodes among the plurality of panel electrodes and the cover lay film are separated by a certain distance.

2. The device of claim 1, wherein the end portions of the two adjacent electrodes among the plurality of panel electrodes are also separated by the certain distance from the cover lay film.

3. The device of claim 1, further comprising:
a conductive material containing conductive balls allowing the plurality of panel electrodes and the plurality of FPC electrodes to be in contact electrically with each other by thermo-compressing the plurality of panel electrodes and the plurality of FPC electrodes.

4. The device of claim 1, wherein the certain distance is within the range of 1.5 mm to 4 mm.

5. The device of claim 3, wherein the size of the conductive balls is within the range of 2 μm to 5 μm.

6. The device of claim 1, wherein the plurality of panel electrodes are one of scan electrodes, sustain electrodes, and address electrodes.

7. The device of claim 1, wherein the plurality of panel electrodes comprise at least one of a transparent electrode and a bus electrode.

8. A plasma display panel device including:
a plasma display panel comprising a plurality of panel electrodes;
a driving circuit to generate a drive signal to drive the panel; and
a flexible printed circuit (FPC) positioned between the panel and a driving board with the driving circuit implemented thereon and transferring the drive signal to the plurality of panel electrodes,
wherein the FPC comprises a plurality of FPC electrodes formed on a base film and compressed with the plurality of panel electrodes and a cover lay film stacked on the plurality of FPC electrodes and the base film, the cover lay film comprises convex portions facing the plurality of panel electrodes and concave portions formed between the convex portions, and a virtual extension line connecting end portions of two adjacent electrodes among the plurality of panel electrodes and the concave portions of the cover lay film are separated by a certain distance.

9. The device of claim 8, further comprising:
a conductive material containing conductive balls allowing the plurality of panel electrodes and the plurality of FPC electrodes to be in contact electrically with each other by thermo-compressing the plurality of panel electrodes and the plurality of FPC electrodes.

10. The device of claim 8, wherein the certain distance is within the range of 1.5 mm to 4 mm.

11. The device of claim 9, wherein the size of the conductive balls is within the range of 2 μm to 5 μm.

12. The device of claim 8, wherein the plurality of panel electrodes are one of scan electrodes, sustain electrodes, and address electrodes.

13. The device of claim 8, wherein the plurality of panel electrodes comprise at least one of a transparent electrode and a bus electrode.

14. A plasma display panel device comprising:
a plasma display panel comprising a plurality of panel electrodes;
a driving circuit to generate a drive signal to drive the panel; and
a flexible printed circuit (FPC) positioned between the panel and a driving board with the driving circuit implemented thereon and transferring the drive signal to the plurality of panel electrodes,
wherein the FPC comprises a plurality of FPC electrodes formed on a base film and compressed with the plurality of panel electrodes and a cover lay film stacked on the plurality of FPC electrodes and the base film, the cover lay film comprises a first layer having at least one step with a first height and a second layer formed with a second height on the first layer, the second layer comprises convex portions facing the plurality of panel electrodes and concave portions formed between the convex portions, and a virtual extension line connecting end portions of two adjacent electrodes among the plurality of panel electrodes and the concave portions of the cover lay film are separated by a certain distance.

15. The device of claim 16, further comprising:
a conductive material containing conductive balls allowing the plurality of panel electrodes and the plurality of FPC electrodes to be in contact electrically with each other by thermo-compressing the plurality of panel electrodes and the plurality of FPC electrodes.

16. The device of claim 14, wherein the certain distance is within the range of 1.5 mm to 4 mm.

17. The device of claim 15, wherein the size of the conductive balls is within the range of 2 μm to 5 μm.

18. The device of claim 14, wherein the first height is lower than the second height.

19. The device of claim 14, wherein the plurality of panel electrodes are one of scan electrodes, sustain electrodes, and address electrodes.

20. The device of claim 14, wherein the plurality of panel electrodes comprise at least one of a transparent electrode and a bus electrode.
